(19) United States
(12) Patent Application Publication
(10) Pub. No.: US 2026/0357027 A1
(43) Pub. Date: Nov. 12, 2026

(54) ISOCYANATE REACTIVE COMPONENT WITH ENHANCED HYDROCARBON COMPATIBILITY

(71) Applicant: Dow Global Technologies LLC, Midland, MI (US)

(72) Inventors: Paolo Golini, Reggio Emilia (IT); Davide Micheletti, Formigine (IT); Oguz Türünç, Livingston (GB)

(21) Appl. No.: 19/129,736

(22) PCT Filed: Dec. 15, 2023
(86) PCT No.: PCT/US2023/084226

§ 371 Date: May 14, 2025

(30) Foreign Application Priority Data
Dec. 16, 2022 (IT) 102022000025812

(51) Int. Cl. C08J 9/14; C08J 9/08; C08K 5/09; C08K 5/17; C08K 5/521; C08L 75/04

(52) U.S. Cl. CPC C08J 9/141; C08J 9/08; C08K 5/09; C08K 5/17; C08K 5/521; C08L 75/04; C08J 2375/04

(57) ABSTRACT

The present disclosure is concerned with an isocyanate reactive component that includes a soybean oil modified aromatic polyester polyol, a terephthalic based polyester polyol, a first EO/PO block copolymer non-ionic surfactant, a phosphorus based fire retardant, a C1-C3 carboxylic acid (e.g., formic acid), a silicon based surfactant, a blowing/gelling catalyst, and a trimerization catalyst.

### FIELD OF DISCLOSURE

Embodiments of the present disclosure are directed towards isocyanate reactive components for forming rigid polyurethane (PU) foams and specifically isocyanate reactive components with enhanced hydrocarbon compatibility for rigid PU foams.

### BACKGROUND

Rigid polyurethane (PU) foams are often used as thermal insulators in construction products, such as preformed construction panels. Rigid PU foams are typically produced by the reaction of an isocyanate with a polyol component, where the reaction mixture is expanded with a blowing agent to provide the foam for the rigid PU foam. The isocyanate, the polyol component, and the blowing agent, together with catalysts and other optional components, are all brought into contact at a dispensing head that dispenses the rigid PU foam formulation. The blowing agent is typically dissolved or emulsified in the polyol component and, during the exothermal reaction between the polyol and isocyanate compounds, volatizes at or above its boiling point to produce the pore or cellular structure of the foam.

In forming the rigid PU foam, the isocyanate is provided in what is termed an “A-side” stream of reagents, while the polyol component is provided in a “B-side” stream of reagents. In addition to the polyol component, the B-side also includes the blowing agent, which is mixed into the polyol component. Of the many blowing agents, a few are preferred due to their lower ozone-depleting properties. Such blowing agents include pentane isomers, such as normal pentane, isopentane, and cyclopentane. Normal pentane and isopentane are the least expensive of the isomers, but they are also the least soluble in the polyol component. Cyclopentane is relatively soluble in the polyol component, but it is expensive and PU foam boards produced with it can demonstrate poor dimensional stability in colder environments. As a result, blends of these various pentane isomers are often used.

Pentane isomers have other issues. For example, at least one issue with using pentane isomers is there tendency to rapidly phase separate in B-side. This can be a problem in case the blowing agent is mixed with the B-side and then added to the dispending tanks of the polyurethane foaming equipment the mixture is allowed to sit idle in the tank. This can happen, for example, when operations are suspended between work shifts (e.g., overnight) or over a weekend. Once separated, the B-side and phase separated blowing agent (e.g., the pentane isomer) needs to be removed from the storage tanks and associated supply lines to allow for a properly mixed B-side and blowing agent to be used in forming the PU foam.

Thus, there is a need in the art for a polyol component that affords enhanced compatibility with hydrocarbon based blowing agents (e.g., does not phase separate) such as pentane isomers for use in the production of rigid PU foams.

### SUMMARY

The present disclosure provides for an isocyanate reactive component that affords enhanced compatibility with hydrocarbon based blowing agents such as pentane isomers for use in the production of rigid PU foams. Specifically, the present disclosure provides for an isocyanate reactive component that includes (i) 5 to 20% by weight of a soybean oil modified aromatic polyester polyol having a hydroxyl number of 250 to 270 mg KOH/g and a functionality of at least about 1.8; (ii) 30 to 65% by weight of a terephthalic based polyester polyol having a hydroxyl number of 200 to 340 mg KOH/g and a functionality of at least about 2; (iii) 1 to 5% by weight of a first EO/PO block copolymer non-ionic surfactant having a weight average molecular weight of 2000 to 3000 g/mol; (iv) 10 to 20% by weight of a phosphorus based fire retardant; (v) 2 to 5% by weight of a C1-C3 carboxylic acid; (vi) 1 to 5% by weight of a silicon based surfactant; (vii) 0.1 to 3% by weight of a blowing/gelling catalyst; and (viii) 0.5 to 5% by weight of a trimerization catalyst; wherein percentages for (i) through (viii) are based on the overall weight of the isocyanate reactive component and the total weight of (i) through (viii) does not exceed 100%.

### DETAILED DESCRIPTION

The present disclosure provides for an isocyanate reactive component that affords enhanced compatibility with hydrocarbon based blowing agents such as pentane isomers for use in the production of rigid polyurethane (PU) foams. Specifically, the present disclosure provides for an isocyanate reactive component that is useful in forming rigid PU foams for use in insulation applications, such as steel faced construction panels, among other products. Surprisingly, the isocyanate reactive component displays enhanced solubility and stability when mixed with a hydrocarbon based blowing agent that is known in the art to quickly separate from this so called “B-side.”. As discussed herein, such blowing agents include, but are not limited to, pentane isomers. As a result, the isocyanate reactive component of the present disclosure can be useful in rigid PU foam processes where there is a likelihood of the isocyanate reactive component sitting idle due to the rigid PU foam being formed in a discontinuous process (e.g., operations are suspended overnight between work shifts or over a weekend).

For the various embodiments, the isocyanate reactive component includes, among other things, a soybean oil modified aromatic polyester polyol having a dicarboxylic acid phthalic backbone, and a first ethylene oxide/propylene oxide (EO/PO) block copolymer non-ionic surfactant that both help in providing enhanced solubility and stability for the blowing agent in the isocyanate reactive component. Additional ingredients in the isocyanate reactive component include, among others, a C1-C3 carboxylic acid (e.g., formic acid) and water that also play a role in the enhanced solubility and stability for the blowing agent in the isocyanate reactive component. In addition, it is recognized that formic acid can also help the aesthetics performance of rigid PU foams formed in a discontinuous injection processes. It has also been surprising found that the isocyanate reactive component containing both the soybean oil modified aromatic polyester polyol and the first EO/PO block copolymer non-ionic surfactant has a significant effect on fire performance of rigid PU foams formed according to the present disclosure.

The above mentioned advantages of the present disclosure are surprisingly achieved using the isocyanate reactive component that includes: (i) 5 to 20% by weight of a soybean oil modified aromatic polyester polyol having a hydroxyl number of 250 to 270 mg KOH/g and a functionality of at least about 1.8; (ii) 30 to 65% by weight of a terephthalic based polyester polyol having a hydroxyl number of 200 to 340 mg KOH/g and a functionality of at least about 2; (iii) 1 to 5% by weight of a first EO/PO block copolymer non-ionic surfactant having a weight average molecular weight of 2000 to 3000 g/mol; (iv) 10 to 20% by weight of a phosphorus based fire retardant; (v) 2 to 5% by weight of a C1-C3 carboxylic acid (e.g., formic acid); (vi) 1 to 5% by weight of a silicon based surfactant; (vii) 0.1 to 3% by weight of a blowing/gelling catalyst; and (viii) 0.5 to 5% by weight of a trimerization catalyst; wherein percentages for (i) through (viii) are based on the overall weight of the isocyanate reactive component and the total weight of (i) through (viii) does not exceed 100%.

The present disclosure further provides a rigid PU foam formed from a reaction mixture that includes (A) an isocyanate component having a functionality of 2.7 to 2.9; (B) the isocyanate reactive component as provided herein; and (C) at least one hydrocarbon blowing agent; wherein the stoichiometric index of the isocyanate component to the isocyanate reactive component is 1.0 to 3.0.

Each of the above components, along with other optional components, of the isocyanate reactive component are discussed as follows. For the various embodiments, hydroxyl numbers (OH-Number, as KOH) can be determined by ASTM D4274, where ASTM D 1957 and ASTM E222-10 also describe methods of determining the hydroxyl number as provided herein; acid number (as KOH) were determined by ASTM D4662. The weight percent (wt. %) values provided for the isocyanate reactive component (e.g., (i) through (xii) are based on the total weight of the isocyanate reactive component, where the total weight percent never exceeds 100 wt. %.

(i)—Soybean Oil Modified Aromatic Polyester Polyol

The isocyanate reactive component includes (i) 5 to 20% by weight of a soybean oil modified aromatic polyester polyol having a hydroxyl number of 250 to 270 mg KOH/g and a functionality of at least about 1.8. As used herein, functionality is the number of chemically active atoms or groups (e.g., —H, —OH, —NCO) per molecule for the considered reaction. This is used as an average value for the soybean oil modified aromatic polyester polyol.

The soybean oil modified aromatic polyester polyol is a reaction product of phthalic anhydride (phthalic based polyester) or phthalic dicarboxylic acid, diethylene glycol (DEG) and soybean oil. The soybean oil modified aromatic polyester polyol includes greater than 0 up to and including 11% by weight of soybean oil. The soybean oil modified aromatic polyester polyol can have a hydroxyl equivalent weight from 208 to 224 g/eq. As used herein, the hydroxyl equivalent weight is the weight of a compound per reactive site and is calculated according to the following equation: Equivalent Weight=(56.1×1000)/OH number. All individual values and subranges from 208 to 224 g/eq are included herein; for example, the soybean oil modified aromatic polyester polyol can have a hydroxyl equivalent weight from a lower limit of 208, 210, 212 or 214 to an upper limit of 224, 222, 220 or 218 g/eq.

The soybean oil modified aromatic polyester polyol can be prepared using known equipment and reaction conditions. In addition, a method of forming the soybean oil modified aromatic polyester polyol is provided in the examples section. Briefly, the soybean oil modified aromatic polyester polyol was produced by mixing 30 to 40 weight percent (wt. %) phthalic anhydride, 45 to 55 wt. % diethylene glycol in a stirred reactor (e.g., glass reactor with stirring) under an inner environment (e.g., nitrogen atmosphere). The mixture was heated to a temperature of 100-130 °C and stirred until a homogeneous mixture was obtained. A titanium actylacetonate catalyst was then added (0.01 to 0.05 wt. %) and the mixture was further heated to 210 °C and left to stir until an acid number of 3 to 5 mg KOH/g was achieved. Then 1 to 11 wt. % of refined soybean oil was added to the reaction mixture and was left to react until acid number of less than 1 mg KOH/g was achieved. The wt. % values are based on the total weight of the reaction mixture for the soybean oil modified aromatic polyester polyol.

The progress of the conversion was monitored with acid number measurements according to the methods in Table 2 of the examples section below. The product was then cooled to 50 to 60 °C and filtered through 25 m filter before use. The final product has an acid number of 0.30 to 0.40, a hydroxyl number of 250 to 270 mg KOH/g and a functionality of at least about 1.8. The functionality of the product was calculated via multiplying the functionality of each building block with its weight percent in the recipe, as in f=2×wt. % phthalic anhydride+2×wt. % DEG+0×wt. % soybean oil)=functionality.

The soybean oil modified aromatic polyester polyol has a functionality of at least about 1.8. For the various embodiments, the functionality of the soybean oil modified aromatic polyester polyol can be from about 1.8 to 2.0. All individual values and subranges from 1.8 to 2.0 for the functionality of the soybean oil modified aromatic polyester polyol are included; for example, the soybean oil modified aromatic polyester polyol can have a functionality from a value of 1.8 or 1.85 to an upper value of 2.0, 1.95 or 1.95 (e.g., 1.8 to 2.0). It is also appreciated that higher functional glycols, such as glycerin, can lead to higher functionality with the same amount of soybean oil.

For the various embodiments, the isocyanate reactive component includes 5 to 20% by weight of the soybean oil modified aromatic polyester polyol. All individual values and subranges from 5 to 20 wt. % of the soybean oil modified aromatic polyester polyol are included herein; for example, the soybean oil modified aromatic polyester polyol can be from a lower limit of 5 or 6 wt. % to an upper limit of 20, 17, 15, 12, 10, or 7 wt. % of the total weight of the isocyanate reactive component. For example, the soybean oil modified aromatic polyester polyol can be from 5 to 15 wt. %; 5 to 10 wt. % 5 to 7 wt. % or 6 to 7 wt. % soybean oil modified aromatic polyester polyol based on the total weight of the isocyanate reactive component.

It is appreciated that soybean oil is a natural product that includes a mixture of different fatty acids (e.g., linoleic acid, oleic acid) that are also found in other naturally occurring oils such as sunflower oil and safflower oil, as examples. As such, the recitation of soybean oil can and does include those other naturally oils that share such overlap with the fatty acids found in soybean oil.

(ii)—Terephthalic Based Polyester Polyol

The isocyanate reactive component includes (ii) 30 to 65% by weight of a terephthalic based polyester polyol having a hydroxyl number of 200 to 340 mg KOH/g and a functionality of at least about 2. As discussed, functionality is the number of chemically active atoms or groups per molecule for the considered reaction, where this is an average value for the terephthalic based polyester polyol.

The terephthalic based polyester polyol can have a hydroxyl equivalent weight from 165 to 280 g/eq, where the hydroxyl equivalent weight is calculated as described herein. All individual values and subranges from 165 to 280 g/eq are included herein; for example, the terephthalic based polyester polyol can have a hydroxyl equivalent weight from a lower limit of 165, 175, 185, 195, or 205 to an upper limit of 280, 270, 260, or 250 g/eq.

The terephthalic based polyester polyol has a functionality of at least about 2. For the various embodiments, the functionality of the terephthalic based polyester polyol can be from 2 to 2.7. All individual values and subranges from 2 to 2.7 for the functionality of the terephthalic based polyester polyol are included herein; for example, the terephthalic based polyester polyol can have a functionality from a value of 2.0 or 2.2 to an upper value of 2.7, 2.5 or 2.3.

The terephthalic based polyester polyol has a hydroxyl number of 200 to 340 mg KOH/g. All individual values and subranges from 200 to 340 mg KOH/g are included herein; for example, the terephthalic based polyester polyol can have a hydroxyl number from a lower limit of 200, 220, 240, or 250 to an upper limit of 340, 320, 300 or 280 mg KOH/g. Preferably, the terephthalic based polyester polyol is a polyester polyol from aromatic terephthalic diacid or diester and a glycol or a polyhydric alcohol and is produced according to known techniques. For example, the terephthalic based polyester polyol can be prepared by reacting an aromatic polyester polyol comprising at least one acid component (e.g., terephthalic acid) and at least one glycol, glycerin and/or polyol component (e.g., ethylene glycol, 1,2-propanediol, 1,3-propanediol, 1,2-butanediol, 1,3-butanediol, 1,4-butanediol. Butanediol, 1,5-pentanediol, 1,6-hexanediol, 1,8-octanediol, 1,9-nonanediol, 3-methyl-1,5-pentanediol, 3,3-Dimethylol heptane, diethylene glycol, dipropylene glycol, neopentyl glycol, diethylene glycol, dipropylene glycol, cyclohexane-1,4-diol, cyclohexane-1,4-dimethanol, dimer acid diol, ethylene oxide and propylene oxide of bisphenol A). Preferably, the terephthalic based polyester polyol is a polyester polyol from an aliphatic or aromatic terephthalic diacid, diethylene glycol and polyethylene glycol, and is produced via a polycondensation reaction according to known techniques. An esterification catalyst can be present in the reaction, where such reactions can take place in an atmosphere of inert gas, e.g., nitrogen, carbon monoxide, helium, argon, etc., at a temperatures of from 150 to 280 °C, optionally under reduced pressure, to the desired acid number.

For the various embodiments, the isocyanate reactive component includes 30 to 65% by weight of the terephthalic based polyester polyol. All individual values and subranges from 30 to 65 wt. % of the terephthalic based polyester polyol are included herein; for example, the terephthalic based polyester polyol can be from a lower limit of 30, 35 or 40 to an upper limit of 65, 60, 55, 50 or 45 wt. % of the total weight of the isocyanate reactive component. For example, the terephthalic based polyester polyol can be from 35 to 65 wt. %; 35 to 55 wt. %; 35 to 45 wt. % or 40 to 45 wt. % terephthalic based polyester polyol based on the total weight of the isocyanate reactive component.

(iii)—First EO/PO Block Copolymer Non-Ionic Surfactant

The isocyanate reactive component includes (iii) 1 to 5% by weight of a first EO/PO block copolymer non-ionic surfactant having a weight average molecular weight of 2000 to 3000 g/mol. Examples of the first EO/PO block copolymer non-ionic surfactant include commercially available products under the trade name Tergitol™ L-61, and Tergitol™ L-64, Tergitol™ L-81, and combinations thereof.

For the various embodiments, the isocyanate reactive component includes 1 to 5% by weight of the first EO/PO block copolymer non-ionic surfactant. All individual values and subranges from 1 to 5 wt. % of the first EO/PO block copolymer non-ionic surfactant are included herein; for example, the first EO/PO block copolymer non-ionic surfactant can be from a lower limit of 1, 1.5 or 2 to an upper limit of 5, 4 or 3 wt. % of the total weight of the isocyanate reactive component. For example, the first EO/PO block copolymer non-ionic surfactant can be from 1 to 4 wt. %; 1.5 to 4 wt. % or 2 to 4 wt. % first EO/PO block copolymer non-ionic surfactant based on the total weight of the isocyanate reactive component.

Preferably, the isocyanate reactive component of the present disclosure can include 5 to 15% by weight of the soybean oil modified aromatic polyester polyol and 2 to 4% by weight of the first EO/PO block copolymer non-ionic surfactant.

(iv)—Phosphorus Based Fire Retardant

The isocyanate reactive component includes (iv) 10 to 20% by weight of a phosphorus based fire retardant. For the embodiments provided herein, the phosphorus based fire retardant is preferably halogen-free and is selected from the group consisting of a phosphate, a phosphonate, a phosphinate and combinations thereof. Examples of the phosphate based fire retardant include trialkyl phosphate, triaryl phosphate, a phosphate ester and resorcinol bis(diphenyl phosphate). As used herein, a trialkyl phosphate has at least one alkyl group with 2 to 12 carbon atoms and optional halogen atoms. The other two alkyl groups of the trialkyl phosphate may, independently be the same or different than the first alkyl group, containing from one to 8 carbon atoms, including a linear or branched alkyl group, a cyclic alkyl group, an alkoxyethyl, a hydroxylalkyl, a hydroxyl alkoxyalkyl group, and a linear or branched alkylene group. Examples of the other two alkyl groups of the trialkyl phosphate include, for example, methyl, ethyl, propyl, butyl, n-propyl, isopropyl. N-butyl, isobutyl, sec-butyl, tert-butyl, butoxyethyl, isopentyl, neopentyl, isohexyl, isoheptyl, cyclohexyl, propylene, 2-methylpropylene, neopentylene, hydroxymethyl, hydroxyethyl, hydroxypropyl or hydroxybutyl. Blends of different trialkyl phosphates may also be used. The three alkyl groups of the trialkyl phosphate may be the same. The trialkyl phosphate can be tris(2-chloro-1-methylethyl) phosphate (TCPP), tris[2-chloro-1-(chloromethyl)ethyl]phosphate (TDCP), tris(p-tertiary-butylphenyl) phosphate (TBPP), and tris(2-chloroethyl) phosphate (TCEP). The trialkyl phosphate is desirably triethyl phosphate (TEP).

Examples of the phosphonate include diethyl (hydroxymethyl)phosphonate, dimethyl methyl phosphonate and diethyl ethyl phosphonate. Examples of the phosphinate include a metal salt of organic phosphinate such as aluminum methylethylphosphinate, aluminum diethylphosphinate, zinc methylethylphosphinate, and zinc diethylphosphinate. Examples of additional halogen-free flame-retardant compounds include resorcinoldiphosphoric acid, 9,10-dihydro-9-oxa-10-phosphaphenanthrene-10-oxide, ammonium polyphosphate and combinations thereof.

For the various embodiments, the isocyanate reactive component includes 10 to 20% by weight of a phosphorus based fire retardant. All individual values and subranges from 10 to 20 wt. % of the phosphorus based fire retardant are included herein; for example, the phosphorus based fire retardant can be from a lower limit of 10, 12 or 13 to an upper limit of 20, 18 or 15 wt. % of the total weight of the isocyanate reactive component. For example, the phosphorus based fire retardant can be from 10 to 18 wt. %; 12 to 18 wt. % or 13 to 15 wt. % phosphorus based fire retardant based on the total weight of the isocyanate reactive component.

(v)—C1-C3 Carboxylic Acid

The isocyanate reactive component includes (v) 2 to 5% by weight of a C1-C3 carboxylic acid (i.e., formic acid, acetic acid and/or lactic acid). For the various embodiments, the isocyanate reactive component includes 2 to 5% by weight of the C1-C3 carboxylic acid. All individual values and subranges from 2 to 5 wt. % of the C1-C3 carboxylic acid are included herein; for example, the C1-C3 carboxylic acid can be from a lower limit of 2, 2.5 or 2.8 to an upper limit of 5, 4.5 or 4 wt. % of the total weight of the isocyanate reactive component. For example, the C1-C3 carboxylic acid can be from 2 to 4.5 wt. %; 2.5 to 4 wt. % or 2.8 to 4 wt. % C1-C3 carboxylic acid based on the total weight of the isocyanate reactive component. Preferably, the C1-C3 carboxylic acid is formic acid.

(vi)—Silicon Based Surfactant

The isocyanate reactive component includes (vi) 1 to 5% by weight of a silicon based surfactant. The silicon based surfactant can help provide stabilization during the polyurethane reaction to avoid cell collapse, especially for low density rigid PU foams. For example, the surfactant can help stabilize the gas bubbles formed by the blowing agent during the foaming process until the polymer has cured. Examples of suitable surfactants include silicone-based surfactants such as polyether polysiloxanes including polysiloxane polyoxylalkylene blockcopolymers and organic-based surfactants containing polyoxyethylene-polyoxybutylene block copolymers. Examples of such silicone surfactants are commercially available under the trade names TEGOSTAB® (Evonik Industries AG), NIAX® (Momentive), and VORASURF® (The Dow Chemical Company). Specific examples of useful surfactants include VORASURF® DC 193, VORASURF® RF 5374, VORASURF® DC 5604, VORASURF® SF 2937, VORASURF® DC 5098, VORASURF® 504, TEGOSTAB® B 8418, TEGOSTAB® B 8491, TEGOSTAB® B 8421, TEGOSTAB® B 8461, and TEGOSTAB® B 8462, NIAX® L-6988, NIAX® L-6642, and NIAX® L-6633 surfactants.

For the various embodiments, the isocyanate reactive component includes 1 to 5% by weight of the silicon based surfactant. All individual values and subranges from 1 to 5 wt. % of the silicon based surfactant are included herein; for example, the silicon based surfactant can be from a lower limit of 1, 1.5 or 2 to an upper limit of 5, 4 or 3 wt. % of the total weight of the isocyanate reactive component. For example, the silicon based surfactant can be from 1 to 4 wt. %; 1.5 to 4 wt. % or 2 to 3 wt. % silicon based surfactant based on the total weight of the isocyanate reactive component.

(vii)—Blowing/Gelling Catalyst

The isocyanate reactive component includes (vii) 0.1 to 3% by weight of a blowing/gelling catalyst. As used herein, blowing catalysts and gelling catalysts, may be differentiated by a tendency to favor either the urea (blow) reaction, in the case of the blowing catalyst, or the urethane (gel) reaction, in the case of the gelling catalyst. For the various embodiments, the blowing/gelling catalyst may include one or more of either a blowing catalyst and/or a gelling catalyst as provided herein or as are known in the art.

Examples of blowing catalysts, e.g., catalysts that can tend to favor the blow reaction include, but are not limited to, short chain tertiary amines or tertiary amines containing oxygen. For instance, blowing catalysts include bis-(2-dimethylaminoethyl) ether; pentamethyldiethylene-triamine, triethylamine, tributyl amine, N,N-dimethylaminopropylamine, dimethylethanolamine, N,N,N′,N′-tetra-methylethylenediamine, and combinations thereof, among others.

Examples of gelling catalysts, e.g., catalyst that can tend to favor the gel reaction, include, but are not limited to, organometallic compounds, cyclic tertiary amines and/or long chain amines, e.g., that contain several nitrogen atoms, and combinations thereof. Organometallic compounds include organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate. Bismuth salts of organic carboxylic acids may also be utilized as the gelling catalyst, such as, for example, bismuth octanoate. Cyclic tertiary amines and/or long chain amines include dimethylbenzylamine, N,N,N′,N′-tetramethylbutanediamine, N,N-dimethylcyclohexylamine, triethylenediamine, and combinations thereof, and combinations thereof.

For the various embodiments, the isocyanate reactive component includes 0.1 to 3% by weight of a blowing/gelling catalyst. All individual values and subranges from 0.1 to 3 wt. % of the blowing/gelling catalyst are included herein; for example, the blowing/gelling catalyst can be from a lower limit of 0.1, 0.12 or 0.14 to an upper limit of 3, 2 or 1.6 wt. % of the total weight of the isocyanate reactive component. For example, the blowing/gelling catalyst silicon can be from 0.12 to 3 wt. %; 0.12 to 2 wt. % or 0.14 to 1.6 wt. % blowing/gelling catalyst based on the total weight of the isocyanate reactive component.

(viii)—Trimerization Catalyst

The isocyanate reactive component includes (viii) 0.5 to 5% by weight of a trimerization catalyst. The trimerization catalyst is a material that promotes the reaction of isocyanate groups with other isocyanate groups to form isocyanurate rings. Useful trimerization catalysts include strong bases such as alkali metal phenolates, alkali metal alkoxides, alkali metal hydroxides, alkali metal carboxylates, quaternary ammonium salts and the like. The alkali metal can be sodium or potassium. Examples of trimerization catalysts include tris(dialkylaminoalkyl)-s-hexahydrotriazines, such as 1,3,5-tris(N,N-dimethylaminopropyl)-s-hexahydrotriazine; [2,4,6-Tris (dimethylaminomethyl) phenol]; N-(2-hydroxylpropyl)-N-tri-methyl ammoniumformate, potassium acetate, potassium octoate; tetraalkylammonium hydroxides such as tetramethylammonium hydroxide; alkali metal hydroxides such as sodium hydroxide; alkali metal alkoxides such as sodium methoxide and potassium isopropoxide; and alkali metal salts of long-chain fatty acids having 10 to 20 carbon atoms and, combinations thereof. Some commercially available trimerization catalysts include DABCO® TMR, DABCO® TMR-2, DABCO® TMR-30, DABCO® K 2097; DABCO® K15, POLYCAT® 41, POLYCAT® 43, and POLYCAT® 46, among others.

For the various embodiments, the isocyanate reactive component includes 0.5 to 5% by weight of a trimerization catalyst. All individual values and subranges from 0.5 to 5 wt. % of the trimerization catalyst are included herein; for example, the trimerization catalyst can be from a lower limit of 0.5, 1, 1.2 or 1.4 to an upper limit of 5, 3 or 2 wt. % of the total weight of the isocyanate reactive component. For example, the trimerization catalyst can be from 0.5 to 3 wt. %; 1 to 2 wt. % or 1.2 to 2 wt. % trimerization catalyst based on the total weight of the isocyanate reactive component.

For the various embodiments, the percentages for (i) through (viii) are based on the overall weight of the isocyanate reactive component and the total weight of (i) through (viii) does not exceed 100%. In one embodiment, the isocyanate reactive component can comprise components (i) through (viii). In an additional embodiment, the isocyanate reactive component can consist essentially of components (i) through (viii). In a further embodiment, the isocyanate reactive component can consist of components (i) through (viii). It is also possible for the isocyanate reactive component of the present disclosure to include other components, such as components (ix) through (xii), as discussed herein. For the various embodiments, when other components are present with (i) through (viii) (e.g., (ix) through (xii) as provided herein), the percentages for the components (e.g., (i) through (xii)) are based on the overall weight of the isocyanate reactive component and the total weight of (i) through (xii) does not exceed 100%.

(ix)—Second EO/PO Block Copolymer Non-Ionic Surfactant

The isocyanate reactive component can optionally include (ix) 0.5 to 1.5% by weight of a second EO/PO block copolymer non-ionic surfactant having a weight average molecular weight of greater than 3000 to 5000 g/mol. For the various embodiments, the second EO/PO block copolymer non-ionic surfactant is different (i.e., not identical) than the first EO/PO block copolymer non-ionic surfactant. Examples of the second EO/PO block copolymer non-ionic surfactant include linear EO/PO block copolymers. The second EO/PO block copolymer non-ionic surfactant can act as defoam/antifoam agent and low foam surfactant. An example of a commercially available second EO/PO block copolymer non-ionic surfactant includes, but is not limited to, DOWFAX™ 92N40, which is available from DOW.

For the various embodiments, the isocyanate reactive component can include 0.5 to 1.5% by weight of the second EO/PO block copolymer non-ionic surfactant. All individual values and subranges from 0.5 to 1.5 wt. % of the second EO/PO block copolymer non-ionic surfactant are included herein; for example, the second EO/PO block copolymer non-ionic surfactant can be from a lower limit of 0.5, 0.55 or 0.6 to an upper limit of 1.5, 1.3 or 1 wt. % of the total weight of the isocyanate reactive component. For example, the second EO/PO block copolymer non-ionic surfactant can be from 0.5 to 1.3 wt. %; 0.5 to 1 wt. % or 0.6 to 1 wt. % second EO/PO block copolymer non-ionic surfactant based on the total weight of the isocyanate reactive component.

(x)—Aromatic Resin-Initiated Polyoxypropylene-Polyoxyethylene Polyol

The isocyanate reactive component can further optionally include up to 25% by weight of (x) an aromatic resin-initiated polyoxypropylene-polyoxyethylene polyol with hydroxyl number of 195 mg KOH/g, an equivalent weight of 286 g/mol, and average functionality of 3.3 (as defined herein). In one embodiment, the aromatic resin-initiated polyoxypropylene-polyoxyethylene polyol can be a Novolac-type polyol, where suitable commercial examples can include Voranol® IP 585 available from The Dow Chemical Company.

For the various embodiments, the isocyanate reactive component can include up to 25% by weight of the aromatic resin-initiated polyoxypropylene-polyoxyethylene polyol. All individual values and subranges up to 25 wt. % of the aromatic resin-initiated polyoxypropylene-polyoxyethylene polyol are included herein; for example, the aromatic resin-initiated polyoxypropylene-polyoxyethylene polyol can be from a lower limit of 5, 10, 15 or 20 to an upper limit of 25 or 23 wt. % of the total weight of the isocyanate reactive component. For example, the aromatic resin-initiated polyoxypropylene-polyoxyethylene polyol can be from 10 to 25 wt. %; 15 to 25 wt. % or 20 to 23 wt. % blowing/gelling catalyst based on the total weight of the isocyanate reactive component.

(xi)—Glycerine Propoxylated Polyether Triol

The isocyanate reactive component further optionally include 1 to 7% by weight of (xi) a glycerine propoxylated polyether triol with an average molecular weight of 1000 g/mol. The glycerine propoxylated polyether triol is a glycerine-initiated polytriolether polyol prepared using known equipment and reaction conditions having a hydroxyl number of 165 mg KOH/g and a functionality (as defined herein) of 3. Suitable commercially available polyether polyols include VORANOL™ 220-110, VORATEC™ SD301, VORANOL™ CP 260, VORANOL™ CP 450, VORANOL™ CP 755, VORANOL™ CP 1000, VORANOL™ CP 1050 and VORANOL™ CP 1055, available from The Dow Chemical Company.

For the various embodiments, the isocyanate reactive component can include 1 to 7% by weight of a glycerine propoxylated polyether triol. All individual values and subranges from 1 to 7 wt. % of the glycerine propoxylated polyether triol are included herein; for example, the glycerine propoxylated polyether triol can be from a lower limit of 1, 2 or 3 to an upper limit of 7, 6 or 5 wt. % of the total weight of the isocyanate reactive component. For example, the glycerine propoxylated polyether triol can be from 2 to 7 wt. %; 2 to 6 wt. % or 3 to 5 wt. % trimerization catalyst based on the total weight of the isocyanate reactive component.

(xii)—Water

The isocyanate reactive component can further include 0.2 to 1% by weight of (xii) water. All individual values and subranges from 0.2 to 1 wt. % of the water are included herein; for example, the water can be from a lower limit of 0.2, 0.4 or 0.6 to an upper limit of 1, 0.9 or 0.8 wt. % of the total weight of the isocyanate reactive component. For example, the water can be from 0.2 to 1 wt. %; 0.4 to 0.9 wt. % or 0.6 to 0.8 wt. % water based on the total weight of the isocyanate reactive component.

(xiii)—Hydrocarbon Blowing Agent

The isocyanate reactive component of the present disclosure can further include 1 to 15 parts by weight of (xiii) a hydrocarbon blowing agent. For the various embodiments, the hydrocarbon blowing agent can be selected from the group consisting of at least one among alkanes such as butane, isobutane, 2,3-dimethylbutane, pentane isomers such as n-pentane and i-pentane, hexane isomers, heptane isomers; cycloalkanes such as cyclopentane, cyclohexane, cycloheptane; HFC-245fa (1,1,1,3,3-pentafluoropropane), HFC-365 mfc (1,1,1,3,3-penta-fluorobutane), HFC-227ea (1,1,1,2,3,3,3-heptafluoropropane), HFC-134a (1,1,1,2-tetrafluoroethane), trans-1-chloro-3,3,3-trifluoropropene, or combinations thereof.

Embodiments of the present disclosure provide that the isocyanate reactive system further include from 1 to 15 parts by weight of the hydrocarbon blowing agent relative to the weight of the isocyanate reactive system. All individual values and subranges from 1 to 15 parts by weight of the hydrocarbon blowing agent are included herein; for example, the hydrocarbon blowing agent can be from a lower limit of 1, 3 or 5 to an upper limit of 15, 12 or 10 parts by weight relative to the weight of the isocyanate reactive system.

Embodiments of the present disclosure include isocyanate reactive component having, in addition to the embodiments provided herein, the following embodiments. An isocyanate reactive component having (i) 6 to 15% by weight of the soybean oil modified aromatic polyester polyol as provided herein; (ii) 35 to 62% by weight of the terephthalic based polyester polyol; (iii) 2 to 4% by weight of the first EO/PO block copolymer non-ionic surfactant; (iv) 12 to 16% by weight of the phosphorus based fire retardant; (v) 2 to 5% by weight of a C1-C3 carboxylic acid (e.g., formic acid); (vi) 2 to 3% by weight of the silicon based surfactant; (vii) 0.1 to 1% by weight of the blowing/gelling catalyst; and (viii) 1 to 3% by weight of the trimerization catalyst; where percentages for (i) through (viii) are based on the overall weight of the isocyanate reactive component and the total weight of (i) through (viii) does not exceed 100%. The present embodiment can further optionally include components (ix) through (xiii) as follows: 0 or 0.7 to 1 by weight of (ix) the second EO/PO block copolymer non-ionic surfactant; 0 or 20 to 25 by weight of (x) the aromatic resin-initiated polyoxypropylene-polyoxyethylene polyol; 0 or by 1 to 7 by weight of (xi) the glycerine propoxylated polyether triol; 0 or by 0.6 to 0.9 by weight of (xii) water; and 1 to 15 parts by weight of (xiii) the hydrocarbon blowing agent. The percentages for (i) through (xii) are based on the overall weight of the isocyanate reactive component and the total weight of (i) through (xii) does not exceed 100%.

An isocyanate reactive component having (i) 6 to 7% by weight of the soybean oil modified aromatic polyester polyol as provided herein; (ii) 40 to 62% by weight of the terephthalic based polyester polyol; (iii) 2 to 4% by weight of the first EO/PO block copolymer non-ionic surfactant; (iv) 12 to 16% by weight of the phosphorus based fire retardant; (v) 2 to 5% by weight of a C1-C3 carboxylic acid (e.g., formic acid); (vi) 2 to 3% by weight of the silicon based surfactant; (vii) 0.1 to 0.5% by weight of the blowing/gelling catalyst; and (viii) 1 to 2% by weight of the trimerization catalyst; wherein percentages for (i) through (viii) are based on the overall weight of the isocyanate reactive component and the total weight of (i) through (viii) does not exceed 100%. The present embodiment can further optionally include components (ix) through (xiii) as follows: 0 or 0.7 to 1 by weight of (ix) the second EO/PO block copolymer non-ionic surfactant; 0 or 20 to 25 by weight of (x) the aromatic resin-initiated polyoxypropylene-polyoxyethylene polyol; 0 or by 1 to 7 by weight of (xi) the glycerine propoxylated polyether triol; 0 or by 0.6 to 0.9 by weight of (xii) water; and 1 to 15 parts by weight of (xiii) the hydrocarbon blowing agent. The percentages for (i) through (xii) are based on the overall weight of the isocyanate reactive component and the total weight of (i) through (xii) does not exceed 100%.

The present disclosure further provides a rigid PU foam formed from a reaction mixture that includes (A) an isocyanate component having a functionality of 2.7 to 2.9; (B) the isocyanate reactive component; and (C) at least one hydrocarbon blowing agent; wherein the stoichiometric index of the isocyanate component to the isocyanate reactive component is 1.0 to 3.0. For the various embodiments, (B) the isocyanate reactive component and (C) the at least one hydrocarbon blowing agent are as described above and herein. For the various embodiments, the reaction mixture can be mixed at a temperature of from 15 to 90 °C, preferably from 20 to 60 °C and in particular from 20 to 35 °C, and introduced onto a work piece (e.g., a steel panel), into the open mold or, optionally under elevated pressure, into the closed mold. Mixing can be carried out mechanically by means of a stirrer or a stirring screw. Reaction temperature for the reaction mixture once dispensed can be from 20 to 110 °C, preferably from 30 to 70 °C and in particular from 40 to 60 °C.

For the various embodiments, the isocyanate component includes at least one polyisocyanate. As used herein, “polyisocyanate” refers to a molecule having an average of greater than 1.0 isocyanate groups/molecule, e.g., an average functionality of greater than 1.0. The isocyanate component can be an aliphatic polyisocyanate, a cycloaliphatic polyisocyanate, an aril-aliphatic polyisocyanate, an aromatic polyisocyanate, or combinations thereof, for example. Examples of isocyanates include, but are not limited to, toluene 2,4-/2,6-diisocyanate (TDI), methylenediphenyl diisocyanate (MDI), polymeric MDI, triisocyanatononane (TIN), naphthyl diisocyanate (NDI), 4,4′-diisocyanatodicyclohexylmethane, 3-isocyanatomethyl-3,3,5-trimethylcyclohexyl isocyanate (isophorone diisocyanatelIPDI), tetramethylene diisocyanate, hexamethylene diisocyanate (HDI), 2-methylpentamethylene diisocyanate, 2,2,4-trimethylhexamethylene diisocyanate (THDI), dodecamethylene diisocyanate, 1,4-diisocyanatocyclohexane, 4,4′-diisocyanato-3,3′-dimethyldicyclohexylmethane, 4,4′-diisocyanato-2,2-dicyclohexylpropane, 3-isocyanatomethyl-1-methyl-1-isocyanatocyclohexane (MCI), 1,3-diisooctylcyanato-4-methylcyclohexane, 1,3-diisocyanato-2-methylcyclohexane, and combinations thereof, among others. As well as the isocyanates mentioned above, partially modified polyisocyanates including uretdione, isocyanurate, carbodiimide, uretonimine, allophanate or biuret structure, and combinations thereof, among others, may be utilized.

The isocyanate component can be polymeric. As used herein “polymeric”, in describing the isocyanate component, refers to higher molecular weight homologues and/or isomers. For instance, polymeric methylene diphenyl isocyanate refers to a higher molecular weight homologue and/or an isomer of methylene diphenyl isocyanate.

For the various embodiments, the stoichiometric index of the isocyanate component to the isocyanate reactive component is 1.0 to 3.0. As known in the art, when the number of isocyanate groups of the isocyanate component equals the number of hydroxyl groups in the isocyanate reactive component the result is a stoichiometric index of the isocyanate component to the isocyanate reactive component of 1.0. When the number of isocyanate groups of the isocyanate component is greater than the number of hydroxyl groups in the isocyanate reactive component (e.g., three times as many) the result is a stoichiometric index of the isocyanate component to the isocyanate reactive component that is greater than 1.0 (e.g., 3.0 for the example).

The isocyanate component can have an isocyanate equivalent weight 130 g/eq to 140 g/eq. All individual values and subranges from 130 g/eq to 140 g/eq are included herein; for example, the isocyanate component can have an isocyanate equivalent weight from a lower limit of 130 or 132 g/eq to an upper limit of 140, 138 or 136 g/eq.

The isocyanate component may be prepared by a known process. For instance, the polyisocyanate can be prepared by phosgenation of corresponding polyamines with formation of polycarbamoyl chlorides and thermolysis thereof to provide the polyisocyanate and hydrogen chloride, or by a phosgene-free process, such as by reacting the corresponding polyamines with urea and alcohol to give polycarbamates, and thermolysis thereof to give the polyisocyanate and alcohol, for example.

The isocyanate component may be obtained commercially. Examples of commercial isocyanates include, but are not limited to, polyisocyanates under the trade names VORANATE™, such as VORANATE™ M 220, and PAPI™ such as PAPI™ 27, available from DOW®, among other commercial isocyanates.

The isocyanate component can be utilized such that the composition for producing the rigid PU foam has an isocyanate index in a range from 100 to 300. Isocyanate index can be determined as a quotient, multiplied by one hundred, of an actual amount of isocyanate utilized and a theoretical amount of isocyanate required for completely reacting all the active hydrogen groups present in the isocyanate reactive system. All individual values and subranges from 100 to 300 are included herein; for example, the foam formulation can have an isocyanate index from a lower limit of 100, 120, or 150 to an upper limit of 300, 250, or 200.

The composition for producing the rigid PU foam disclosed herein can be cured to form a rigid PU foam having a core density of greater than 30 kg/m³. As used herein, the core density of a PU foam is determined from the middle interior section of a molded foam as its mass per unit of volume. The foam core density is generally lower than the apparent density calculated by dividing the foam mass by its entire volume due to the density variation from skin to core in the molded foam. The rigid PU foam can be prepared by using known methods and conditions, which may vary for different applications. One or more embodiments of the present disclosure provide a process for forming a rigid polyurethan foam product. The process includes curing the reaction mixture disclosed herein. The process may utilize known equipment and conditions, such as a one shot process, among others.

One or more embodiments of the present disclosure provide that the composition for producing the rigid PU foam can include one or more additional components. Different additional components and/or different amounts of additional components may be utilized for various applications. Examples of additional components include pigments, colorants, additional flame retardants as are known in art, crosslinkers, chain extenders, antioxidants, bioretardant agents, and combinations thereof, among others.

### EXAMPLES

The examples below are provided to be illustrative only and are not intended to define or limit the embodiments in any way. All compounds were acquired from Sigma-Aldrich, unless otherwise noted. In the Inventive Examples (EX) and Comparative Examples (CE), various terms and designations for materials are used including, for instance, the following:

TABLE 1
Materials

| Category | Chemical/Designation Name | Specification | Supplier |
|---|---|---|---|
| Polyester Polyol 1 | A polyester polyol from terephtalic | IP-9001 | The Dow Chemical |
| | acid, diethylene glycol and | | Company (DOW) |
| | polyethylene glycol; functionality = 2, | | |
| | OH number = 220 | | |
| Nonionic Surfactant 1 | Second EO/PO block copolymer non- | DOWFAX ™ | DOW |
| | ionic surfactant - Linear block | 92N40 | |
| | copolymer of EO and PO | | |
| Polyol 2 | An aromatic resin-initiated | Polyol IP 585 | DOW |
| | polyoxypropylene-polyoxyethylene | | |
| | polyol (Novolac-type polyol) with | | |
| | hydroxyl number of 195 mg KOH/g, an | | |
| | equivalent weight of 286, and average | | |
| | functionality of 3.3 | | |
| Polyol 3 | A glycerine propoxylated polyether | Voranol ™ CP | DOW |
| | triol with an average molecular weight | 1055 Polyol | |
| | of 1000 | | |
| Isocyanate, Polymeric | Polymethylene polyphenylisocyanate, | VORANATE ™ | DOW |
| MDI | total isocyanate content of about 31% | M 220 | |
| | and an average functionality of 2.7 | | |
| Fire Retardant | Triethyl Phosphate | Triethyl Phosphate | Sigma-Aldrich |
| Catalyst 1 | N,N-Dimethylcyclohexylamine | Polycat ® 8 | Evonik |
| Catalyst 2 | Trimerization Catalyst | Dabco ® K2097 | Evonik |
| Chemical blowing agent | Formic Acid | | Sigma-Aldrich |
| Polyether Polysiloxane | A hydrolysis-resistant polyether | Tegostab ® B | Evonik |
| | polydimethylsiloxane copolymer | 8491 | |
| Polyester Polyol 2 | Soybean oil- phthalic anhydride based | | |
| | polyester polyol | | |
| Nonionic Surfactant 2 | First EO/PO block copolymer non-ionic | Tergitol ™ L-64 | DOW |
| | surfactant | | |
| Hydrocarbon Blowing | n-pentane | | Sigma-Aldrich |
| Agent | | | |
| Hydrocarbon Blowing | Cyclopentane | | Sigma-Aldrich |
| Agent | | | |
| Chemical blowing agent | Water | DI water | |

### Production of Polyester Polyol 2.

Polyester Polyol 2 was produced as follows. Phthalic anhydride (3755.3 g, 37.6 wt. % a) and diethylene glycol (5144.7 g, 51.4 wt. %) were weighted into a glass reactor under nitrogen atmosphere, equipped with a mechanical stirrer, thermocouple, nitrogen inlet and a distillation bridge. The reactor was brought to a temperature range of 110-120 TC and let to stir until a homogeneous mixture was obtained. After that, titanium actylacetonate catalyst (Tyzor AA-105 from Dorf Ketal) was added (3.00 g, 0.03 wt. %) and the mixture was further heated to 210 TC and left to stir until an acid number of 3 to 5 mg KOH/g was achieved. Then refined soybean oil (1100.0 g, 11.0 wt. %) was added to the reaction mixture and was left to react until Acid number of <1 mg KOH/g was achieved. The progress of the conversion was monitored with acid number measurements according to the methods in Table 2. The product was then cooled to 50-60 TC and filtered through 25 μm filter before use. The final product had an acid number of 0.37 and hydroxyl number of 262.5 mg KOH/g. The functionality of the product was calculated via multiplying the functionality of each building block with its weight percent in the recipe, as in f=2×37.6% (for phthalic anhydride)+2×51.4% (for DEG)+0×11.0% (for soybean oil)=1.8.

TABLE 2
Analytical Methods Used in Polyester Polyol Synthesis
and the results for Polyester Polyol 2

| | | | Analysis Results |
|---|---|---|---|
| | | | for Polyester |
| Test | Unit | Test Method | Polyol 2 |
| OH-Number (as KOH) | mg/g | ASTM D4274 | 262.5 |
| Acid Number (as KOH) | mg/g | ASTM D4662 | 0.37 |

### Tests

NBS smoke chamber test (optical density of smoke) conducted according to ASTM E 662. Flame spreading test conducted according to DIN 4102-1.

### Samples

Polyurethane Examples (EX) and Comparative Examples (CE) where formed as follows. Rigid blown foams are manufactured by reaction of formulated polyol, containing hydrocarbon blowing agent, and polymeric isocyanate (both kept at 20 °C). The two components are homogeneously mixed by suitable device operating at 2500 rounds per minute and poured in a 20 cm×20 cm×8 cm mold kept at 50 °C. Demolding occurred after 20 minutes. Foam specimens were then cut at desired dimensions required by fire test methods.

TABLE 2A

| Component | EX 1 | EX 2 | EX 3 | EX 4 | EX 5 | EX 6 | EX 7 |
|---|---|---|---|---|---|---|---|
| Polyester Polyol 1 (g) | 42 | 42 | 42 | 42 | 61.5 | 42 | 42 |
| Nonionic Surfactant 1 | 0.7 | 0.7 | 0.7 | 0.7 | 1.0 | 0.7 | 0.7 |
| (g) | | | | | | | |
| Polyester Polyol 2 (g) | 6.3 | 6.3 | 6.3 | 6.3 | 6.0 | 6.3 | 6.3 |
| Polyol 2 (g) | 22.5 | 22.5 | 22.5 | 22.5 | 0 | 22.5 | 22.5 |
| Polyol 3 (g) | 3.45 | 1.45 | 4.25 | 2.25 | 6.45 | 3.45 | 3.45 |
| Fire Retardant (g) | 14 | 14 | 14 | 14 | 14 | 14 | 14 |
| Catalyst 1 (g) | 0.15 | 0.15 | 0.15 | 0.15 | 0.15 | 0.15 | 0.15 |
| Catalyst 2 (g) | 1.5 | 1.5 | 1.5 | 1.5 | 1.5 | 1.5 | 1.5 |
| Nonionic Surfactant 2 | 2 | 4 | 2 | 4 | 2 | 2 | 2 |
| (g) | | | | | | | |
| Formic Acid (g) | 4 | 4 | 2.9 | 2.9 | 4 | 4 | 4 |
| Water (g) | 0.6 | 0.6 | 0.9 | 0.9 | 0.6 | 0.6 | 0.6 |
| Polyether Polysiloxane | 2.8 | 2.8 | 2.8 | 2.8 | 2.8 | 2.8 | 2.8 |
| (g) | | | | | | | |
| Total Premix | 100 | 100 | 100 | 100 | 100 | 100 | 100 |
| Normal Pentane (parts | 5.8 | 5.8 | 5.8 | 5.8 | 5.8 | 0 | 0 |
| by weight) | | | | | | | |
| Cyclopentane (parts by | 0 | 0 | 0 | 0 | 0 | 7 | 9 |
| weight) | | | | | | | |
| Fully blend aspect | ok | ok | ok | ok | ok | ok | ok |
| Voranate ™ M 220 (g) | 193 | 193 | 193 | 193 | 193 | 193 | 193 |
| molded foam, | 45 | 46 | 46 | 45 | 45.5 | 45.5 | 46 |
| 20 cm × 20 cm × 8 cm, | | | | | | | |
| 50 °C, density (g/L) | | | | | | | |
| NBS smoke chamber | 20.1 | not | not | not | not | not | not |
| test, ASTM E 662- | | measured | measured | measured | measured | measured | measured |
| Max Ds | | | | | | | |
| DIN 4102 fire test, | done | | | | | done | |
| flame spread (mm) | | | | | | | |
| specimen 1 | 80 | | | | | 90 | |
| specimen 2 | 100 | | | | | 95 | |
| specimen 3 | 80 | | | | | 100 | |
| specimen 4 | 85 | | | | | 95 | |
| specimen 5 | 85 | | | | | 95 | |
| average flame spread | 86.0 | | | | | 95.0 | |
| (mm) | | | | | | | |

TABLE 2B

| Component | CE A | EX 8 | EX 9 | CE B | CE C | CE D |
|---|---|---|---|---|---|---|
| Polyester Polyol 1 (g) | 47 | 42 | 35 | 35 | 42 | 42 |
| Nonionic Surfactant 1 | 2 | 0 | 0 | 0 | 2 | 0 |
| (g) | | | | | | |
| Polyester Polyol 2 (g) | 0 | 7 | 14 | 14 | 7 | 7 |
| Polyol 2 (g) | 22.5 | 22.5 | 22.5 | 22.5 | 22.5 | 22.5 |
| Polyol 3 (g) | 3.45 | 3.45 | 3.15 | 5.15 | 3.45 | 5.45 |
| Fire Retardant (g) | 14 | 14 | 14 | 14 | 14 | 14 |
| Catalyst 1 (g) | 0.15 | 0.15 | 0.15 | 0.15 | 0.15 | 0.15 |
| Catalyst 2 (g) | 1.5 | 1.5 | 1.5 | 1.5 | 1.5 | 1.5 |
| Nonionic Surfactant 2 | 2 | 2 | 2 | 0 | 0 | 0 |
| Formic Acid (g) | 4 | 4 | 4 | 4 | 4 | 4 |
| Water (g) | 0.6 | 0.6 | 0.9 | 0.9 | 0.6 | 0.6 |
| Polyether | 2.8 | 2.8 | 2.8 | 2.8 | 2.8 | 2.8 |
| Polysiloxane (g) | | | | | | |
| Total Premix (g) | 100 | 100 | 100 | 100 | 100 | 100 |
| Normal Pentane (parts | 0 | 0 | 0 | 0 | 0 | 0 |
| by weight) | | | | | | |
| Cyclopentane (parts | 7 | 7 | 7 | 7 | 7 | 9 |
| by weight) | | | | | | |
| Fully blend aspect | Phase | ok | ok | PS | PS | PS |
| | Separation | | | | | |
| | (PS) | | | | | |
| Voranate ™ M 220 (g) | 193 | 193 | 195 | 193 | | |
| molded foam, | 44.7 | 45.4 | 46 | 46 | not | not molded |
| 20 × 20 × 8 cm, | | | | | molded | |
| 50 °C, density (g/L) | | | | | | |
| DIN 4102 fire test, | | | | | | |
| flame spread (mm) | | | | | | |
| specimen 1 | 95 | 90 | 100 | 105 | | |
| specimen 2 | 95 | 105 | 125 | 115 | | |
| specimen 3 | 105 | 90 | 105 | 105 | | |
| specimen 4 | 100 | 90 | 105 | 105 | | |
| specimen 5 | 100 | 100 | 110 | 110 | | |
| average flame spread | 99 | 95 | 109 | 108 | | |
| (mm) | | | | | | |

Each of CE A through CE D showed phase separation. In contrast, each of the examples exhibited a fully formulated blend (i.e., were homogeneous and did not separate) that was a clear liquid and provided unexpected and beneficial fire performance as shown by EX. 8 (Table 2B). It is believed that is unexpected result was facilitated by the combination of Nonionic surfactant 2 and soybean oil derivative, the last one used in the recited amounts for the preformulated polyol mix, once compared with other examples containing same type and amount of hydrocarbon blowing agent.

1. An isocyanate reactive component, comprising:
(i) 5 to 20% by weight of a soybean oil modified aromatic polyester polyol having a hydroxyl number of 250 to 270 mg KOH/g and a functionality of at least about 1.8;
(ii) 30 to 65% by weight of a terephthalic based polyester polyol having a hydroxyl number of 200 to 340 mg KOH/g and a functionality of at least about 2;
(iii) 1 to 5% by weight of a first EO/PO block copolymer non-ionic surfactant having a weight average molecular weight of 2000 to 3000 g/mol;
(iv) 10 to 20% by weight of a phosphorus based fire retardant;
(v) 2 to 5% by weight of a C1-C3 carboxylic acid;
(vi) 1 to 5% by weight of a silicon based surfactant;
(vii) 0.1 to 3% by weight of a blowing/gelling catalyst; and
(viii) 0.5 to 5% by weight of a trimerization catalyst; wherein percentages for (i) through (viii) are based on the overall weight of the isocyanate reactive component and the total weight of (i) through (viii) does not exceed 100%.

2. The isocyanate reactive component of claim 1, further including (ix) 0.5 to 1.5% by weight of a second EO/PO block copolymer non-ionic surfactant having a weight average molecular weight of greater than 3000 to 5000 g/mol, wherein the second EO/PO block copolymer non-ionic surfactant is different than the first EO/PO block copolymer non-ionic surfactant and wherein percentages for (i) through (ix) are based on the overall weight of the isocyanate reactive component and the total weight of (i) through (ix) does not exceed 100%.

3. The isocyanate reactive component of claim 1, further including up to 25% by weight of (x) an aromatic resin-initiated polyoxypropylene-polyoxyethylene polyol with hydroxyl number of 195 mg KOH/g, an equivalent weight of 286, and average functionality of 3.3.

4. The isocyanate reactive component of claim 1, further including 1 to 7% by weight of (xi) a glycerine propoxylated polyether triol with an average molecular weight of 1000.

5. The isocyanate reactive component of claim 1, further including 0.2 to 1% by weight of (xii) water.

6. The isocyanate reactive component of claim 1, wherein the soybean oil modified aromatic polyester polyol is a reaction product of phthalic anhydride, diethylene glycol and soybean oil.

7. The isocyanate reactive component of claim 6, wherein the soybean oil modified aromatic polyester polyol includes up to 11% by weight of soybean oil.

8. The isocyanate reactive component of claim 1, further including a hydrocarbon blowing agent selected from the group consisting of at least one among butane, isobutane, 2,3-dimethylbutane, n-pentane, i-pentane, hexane isomers, heptane isomers, cyclopentane, cyclohexane, cycloheptane, HFC-245fa (1,1,1,3,3-pentafluoropropane), HFC-365 mfc (1,1,1,3,3-penta-fluorobutane), HFC-227ea (1,1,1,2,3,3,3-heptafluoropropane), HFC-134a (1,1,1,2-tetrafluoroethane), trans-1-chloro-3,3,3-trifluoropropene, or combinations thereof.

9. The isocyanate reactive component of claim 1, wherein the isocyanate reactive component includes 5 to 15% by weight of the soybean oil modified aromatic polyester polyol and 2 to 4% by weight of the first EO/PO block copolymer non-ionic surfactant.

10. A rigid polyurethane foam formed from a reaction mixture comprising:
(A) an isocyanate component having a functionality of 2.7 to 2.9;
(B) the isocyanate reactive component of any one of claims 1-9; and
(C) at least one hydrocarbon blowing agent; wherein the stoichiometric index of the isocyanate component to the isocyanate reactive component is 1.0 to 3.0.
